(19) United States
(12) Patent Application Publication
(10) Pub. No.: US 2013/0326002 A1
(43) Pub. Date: Dec. 5, 2013

(54) Network Isolation

(71) Applicants: Sebastian Leuoth, Zschorlaub (DE); Alexander Adam, Reichenbach (DE)

(72) Inventors: Sebastian Leuoth, Zschorlaub (DE); Alexander Adam, Reichenbach (DE)

(21) Appl. No.: 14/000,837

(22) PCT Filed: Jan. 20, 2012
(86) PCT No.: PCT/EP2012/050829

§ 371 Date: Aug. 21, 2013

(30) Foreign Application Priority Data
Feb. 22, 2011 (DE) 10 2011 000 876.4

(51) Int. Cl. H04L 29/08

(52) U.S. Cl. CPC H04L 29/08549
USPC 709/216

(57) ABSTRACT

The present description proposes an interface, a method and a system for data transmission from a first data-processing system to at least one second data-processing system. The interface comprises a first application-specific connector, which can interchange data specific to a first application of the first data-processing system with said first application, at least one second application-specific connector, which can interchange data specific to a second application of at least one second data-processing system with said second application, and a data memory which can be accessed by the first connector and the second connector.

The present description refers to a device, a method and a system for an interface for data transmission from a first data-processing system to a second data-processing system. Specifically, the interface can be used to connect private computers, databases or networks to public networks such as the Internet or other networks.

Today, databases form for a company the central point in which all relevant information of the company is stored. On the one hand, all employees and processes of the company must have access to this data stock. On the other hand, these data also need to be protected from unauthorised access. The effort required for this protection increases along with the number of users that have access to potential access points. At the same time, the risk of an open gap in the safety structure increases.

One of the most critical points in the safety-technical infrastructure is the transmission or transition between safety areas, e.g. between an internal company network and an external network (usually the Internet). Precisely the Internet, as a universal interface to nearly any person, takes a central role in the cooperation between customers/partners and the company.

For this reason, more and more information and processes are mapped via this interface. Examples from the banking sector are online banking or the creation of an account online, via Internet. Another example is the transmission of measured values from private wind parks to the control system of large energy suppliers. These examples represent many other cases in which network-comprehensive data interchange and access to specific applications is desired.

Based on the continually growing number of published weaknesses in IT products, there is the risk that more and more systems can be taken over without any great effort, which gives such unauthorized persons relatively easy access to sensitive data of the company.

Additional databases are installed to avoid giving a user direct access to a central database or application. These additional databases contain only the data stock or copies of the data necessary for the respective application.

The safety-technical risk arises in the location where the data are reconciled or matched. Today, techniques of replication are being used to maintain a consistent data stock. If performing this matching or reconciliation in a controlled environment, e.g. at specified times, under the supervision of staff, the risk of an intruder successfully using this communications line to get into the company network or to the data stock is low. This rather theoretic approach is not accepted by the user, since he may only receive feedback to his actions after hours, or even only once a day. A second disadvantage is in the staff requirements for performing such monotonous processes cyclically.

For this reason, there are permanent communications connections or interfaces such as Ethernet, InfiniBand or TCP/IP-based connections (communications network) between internal and external networks that can be exploited for successful attacks at any time to acquire access to the most sensitive data.

To prevent direct routing through a communication connection, WO 2009/075656 suggests an interface called the “Virtual air gap”, in which an internal network and an external network each communicate with an internal respectively external safety element. The safety elements translate instructions from the external network into an especially encrypted format and save it in a shared memory from which the encrypted information is read and re-translated into the instruction.

The communication takes place on one of the lower layers (TCP/IP, Layer 4 ISO/OSI-model). Additionally, encryption is used for safety.

One object of the present invention is therefore to provide a secure interface that overcomes the disadvantages of the state of the art.

### SUMMARY OF THE INVENTION

The present description suggests an interface, a method and a system for data transmission from a first data-processing system to at least one second data-processing system. The data-processing systems may be individual computers or processors, or comprise networks. For example, the first data-processing system may be a secure private network and the second data-processing system is the Internet.

The system comprises a first application-specific connector, which can interchange, with a first application of the first data-processing system, data specific for the first application, at least one second application-specific connector, which can interchange, with a second application of at least one second data-processing system, data specific for the second application, and a data memory to which the first connector and the second connector have access. An instruction from the first application is stored in the memory by the first connector and read from the memory by the second connector.

The interface comprises a first application-specific connector, which can interchange, with a first application of the first data-processing system, data specific for the first application, at least one second application-specific connector, which can interchange, with a second application of at least one second data-processing system, data specific for the second application, and a data memory to which the first connector and the second connector have access.

The method comprises the reception of a change or instruction to be transmitted from a first application from the first data-processing system, storing of the change to be transmitted in a memory through a first connector, reading of the change stored in the memory and to be transmitted by a second connector, determination of whether the change to be transmitted is to be forwarded to the second data-processing system, forwarding of the change to be transmitted to a second application in the second data-processing system once it has been determined that the instruction to be transmitted is to be forwarded into the second data-processing system.

With the device, the method and the system, two or several data-processing systems that should communicate with each other in any chosen way can be connected asynchronously and non-routing-capably with each other in a novel manner.

The first and/or second data-processing system may be a single processor or a database. Specifically, the data-processing system may also be a network of several computers, such as a company-internal network or a generally accessible or external network like the Internet. The expressions “first data-processing system” and “second data-processing system” may be interchangeable if the connection is bidirectional. For example, the first data-processing system may be an external network and the second data-processing system may be a computer or an internal network, or vice versa. The interface according to the invention may be used in any interface between two systems that interchange data with each other.

By using the suggested device, method and/or system, a secure network isolation is created that reliably prevents the unauthorized intrusion from the first network to the second network. The first data-processing system and the second data-processing system may be data networks that are physically separate from each other, with the only physical connection being the memory. The complete network isolation can be implemented because the communication between the networks according to the present disclosure is changed or transferred from the principle of data transmission (ISO/OSI) to the principle of data memory. This achieves a complete uncoupling on the technical communication layer, which is not limited to specific network configurations and/or application cases.

The first application-specific connector receives and, if applicable, transmits data directly from the first application. The data or changes of the data or instructions or orders are specific for the respective application, e.g. a database. The data or changes to the data or instructions or orders may, for example, be SQL-specific or specific for Oracle databases. The data or changes to the data or instructions or orders may be transmitted to a higher ISO/OSI layer, e.g. on at least one of the layers 5 (session layer), 6 (presentation layer) or 7 (application layer).

In a same manner, the second connector transmits and, if applicable, receives, data directly to/from the second application. The first application and the second application may be equal to or different from each other.

The first connector may store the data in a generally valid or universal format in the memory. The second connector then reads the data in the generally valid or universal format, changes them into data, changes, instructions or orders specific for the second application and submits them to the second application.

The use of the first application-specific connector and of the second application-specific connector permits waiver of encoding of the data or information stored in the memory.

The memory may comprise at least one first area into which only the first connector may write. The at least second connector and possibly when applicable other connectors may read this first area. For an at least bidirectional interface, the memory may comprise at least one second area, into which only the second connector can write. The at least first connector and poss. other connectors may read this first area.

For example, the present disclosure permits synchronizing a data stock present separately in each network by doubling in current operation in such a way that data integrity is warranted and the separate data stocks appear in each of the involved networks like a single data stock (virtual data stock).

It is also possible to have various heterogeneous networks communicate in any manner and to make them appear to a user of the communication as homogeneous (virtual network, cloud).

### DESCRIPTION OF FIGURES

Examples of the present invention are explained below based on the enclosed figures, which only show examples for the present description and wherein:

FIG. 1 shows an interface according to the state of the art;

FIG. 2 shows an interface as it can be used with the present description;

FIG. 3 shows the connection within the connectors, the central elements of the interface;

FIG. 4 shows the central elements of one side of the interface;

FIG. 5 shows the OSI layers of an interface; and

FIG. 6 shows the communication layers in an interface.

### DETAILED DESCRIPTION

The following description of examples for this invention is only exemplary and not limiting. A person skilled in the art will recognize that the described features are not all required for carrying-out the invention and that the different features can be combined freely with each other.

A network in the sense of the present description comprises a data processing network (DV-network). A network is a data processing environment in which DV-components, hereinafter also designated as components, communicate with each other through a shared protocol.

A network may be public, i.e. the components can be accessed or used by any other components. There is no existence or evidence of a non-technical association between the components. Authentication of the components is independent of this. Examples: Internet, “Public Clouds”, kiosk systems, etc.

A network may be non-public, i.e. private or internal. In this case, there is a form of non-technical association of components that defines or specifies the privacy. The components of a private network are only available to such components that are subject to either the same or another non-technical association, but in this case authorised by the first mentioned components. Authentication of the components is also independent of this. Examples: companies or authority networks, so-called Intranets, so-called “Private Clouds”, etc.

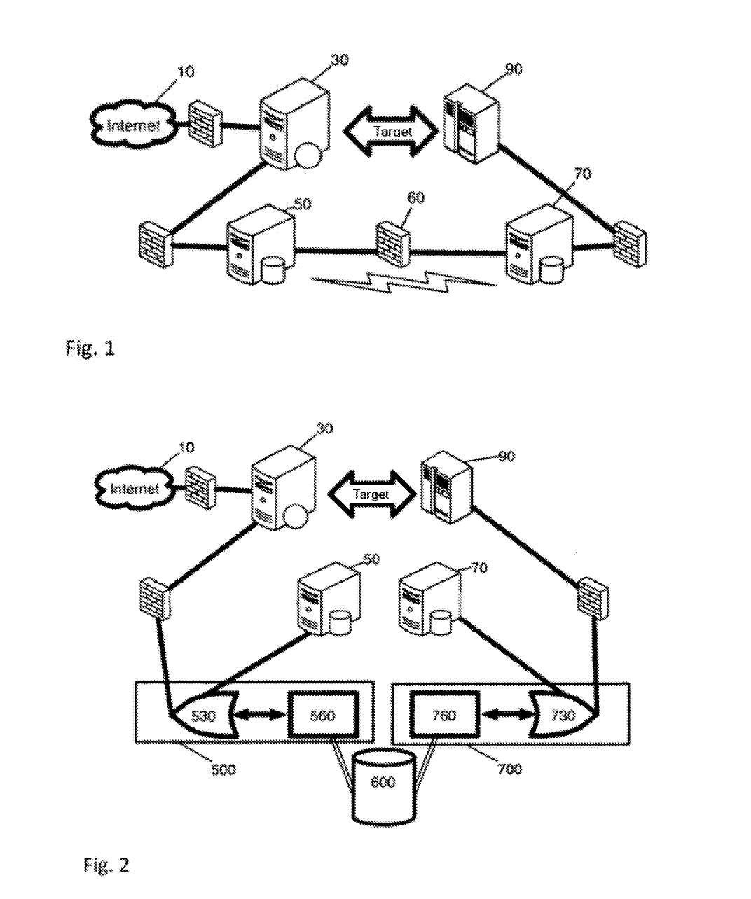

FIG. 1 shows an interface as it is usually used for the connection of networks. For many applications, a network-comprehensive data interchange from an external or public network 10, such as the Internet, with data of an internal or private network 90 is required. The internal data are often stored in an internal or central database 70. To avoid giving a user direct access to the central database 70, additional databases 50 are installed that a user may access. These additional databases 50 contain only the data stock that is necessary for the respective application.

A safety-technical risk arises at the interface 60 between the central database 70 and the additional database 50 where the data matching takes place. Today, replication techniques are used at this interface 60 to maintain a consistent data stock in the central database 70 and the additional database 50. For this, there are permanent communications connections 6 between internal 90 and external networks 10, which may be exploited at any time by a successful attack to acquire access to the most sensitive of data.

A protocol is an agreement on the conduct of components in certain situations of communication and/or use among each other. Protocols specify what a component has to do or how to react if another component reports to it with a specific order or request. The protocols used for communication in networks may be consistent or different (Examples: HTTP, WAP, CSMA/CD, TCP/IP, UDP/IP, etc.).

The interface 60 shown in FIG. 1 is generally routing-capable. The term routing-capable describes the possibility of technically creating a transmission between two or more nodes of a network—e.g. between the respective end nodes of two networks.

The interface 60 shown in FIG. 1 via a communication connection is a synchronous communication connection. A synchronous communication requires that the communicating components perform an information or data interchange at the same time and following a protocol. Example: phone, Session Initiation Protocol (SIP).

FIG. 2 shows an interface between an external data-processing system 10, 30, such as the Internet 10 and/or computers 30 connected to it and an internal data-processing system 90. In contrast to the common embodiment of FIG. 1, there is no direct or routing-capable connection between the external data-processing system 10, 30 and the internal data-processing system 90 and therefore also no direct or synchronous connection of the central database 70 with the additional database 50.

In the interface illustrated in FIG. 2, a memory 600 is provided that forms the only connection between the external data-processing system 10, 30 and the internal data-processing system 90; there is no communication connection in parallel to the memory. The memory 600 may comprise one or several hard discs, fiber channel or other memory elements or a combination of them. At least two connectors 500, 700 have access to the memory 600, wherein at least one external connector 500 communicates with the external data-processing system 10, 30 and at least one internal connector 700 communicates with the internal data-processing system 90.

Each of the connectors comprises at least one connector and one processor, wherein the connector communicates and may interchange data with the respective data-processing system via an interface that is known as such. The processor processes the data received from the connector and passes them on to the memory 600 or reads data from the memory 600 and transmits them to the connector for further transmission.

The connector may be designed as a software module or hardware module or a combination of both.

In the example shown in FIG. 2, the external connector 500 comprises an external connector 530 in a communication connection with the external data-processing system 10, 30 and an external processor 560, which accesses the memory 600. The internal connector 700 comprises an internal connector 730 in communication with the internal data-processing system 90 and an internal processor 760 that also accesses the memory 600.

The connection is in this case an asynchronous communication connection. Asynchronous communication permits interchange of information or data between communicating components, in a time-delayed manner and also following a protocol. Example: email, Simple Mail Transfer Protocol (SMTP).

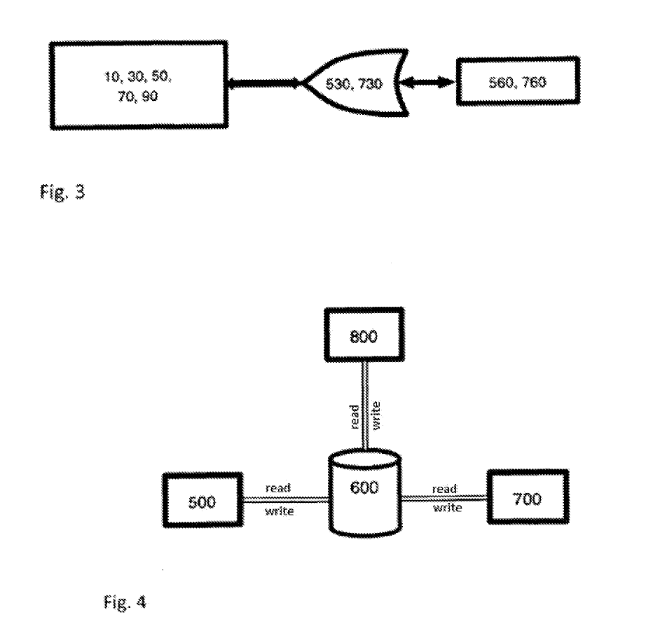

As shown in FIG. 3 and suggested above, the memory 600 is exclusively used by the internal processor 560 and the external processor 760 and, if applicable, by further processors. Other components than the processors cannot access the memory 600, and in any case not write into or on it. The external and internal processors 560, 760 can read from and write into the memory 600 without requiring synchronization. The method works asynchronously and the memory 600 can only be used by the processors 560, 760. There are no file system functions.

For each processor, at least one area in the memory 600 is reserved into which only the corresponding processor may write. An external area 650 is reserved in the memory 600 for the external processor 560. Only the external processor 560 may write to this external area 650 of the memory 600. The external area 650 may be read by the internal processor 760 and possibly other processors. Similarly, an internal area 670 is reserved in the memory for the internal processor 760, into which only the internal processor 760 may write. The external processor 560 and possibly other processors may read this internal area 670. The communication via the memory can therefore be described as asynchronous.

The respective connectors 530, 730 are docked to these processors 560, 760. The connectors may send messages to the processors and receive messages from them. A message may be a combination of receiver part and data part, whereby a controlled distribution of information is obtained. The connector is the interface to the respective communication network or data-processing system, the external connector 530 is the interface with the external data-processing system 10, 30 and the internal connector 730 is the interface with the internal data-processing system 90. Each connector 530, 730 has the possibility of accepting connections. It can build up connections independently. For example, the external connector 530 can connect to the additional database 50 or the external computer 30. Similarly, the internal connector 730 may connect to the central database 70 or an internal computer 90 and interchange data with them. Each connector has a special type that is adjusted to the data source and/or the application. For example, a connector can directly communicate with an Oracle database or with a database in SQL and request data from it or change them. This is generally termed “change” in the present application.

A change to be performed starts with the acceptance of a communication connection. A data change order or request is sent by a user who has access from the Internet 10 through the external connector 530 to the external processor 560. It forwards the request to the additional database 50 and addresses in parallel this change request to the internal processor 760 by writing it to the memory 600. The internal processor 760 verifies at defined time intervals whether there are any new change requests in the memory 600 and thus finds the new request. Then the internal processor 760 forwards this request through the internal connector 730 e.g. to the central database 70. After processing of the request, feedback to the external processor 560 is given via the same path. According to this PO box principle, requests or orders would also be processed in the opposite direction or to other connectors 800.

The terms external and internal are only used as examples in the present description to describe the interface and its function based on an interface between an external network, such as the Internet, and an internal network or computer, such as a company network. This illustration corresponds only to an application example, however, and the interface may also be used for any other type of connection of data-processing systems.

The illustration of FIGS. 2 and 3 also shows only the connection of two data-processing systems for reasons of illustration. This disclosure is, however, not limited to this, but any number of connectors may be connected to the memory 600. FIG. 4 shows exemplarily that a third connector 800 may operate additionally in the memory in addition to the external connector 500 and the internal connector 700. Any number of other connectors may be added if desired. The third connector may be connected to the external data-processing system 10, 30, the internal data-processing system 90 or a third data-processing system.

As an example, a web-service connector, as which the external connector 530 may be implemented in this example, can receive instructions from a data source via HTTP protocol, which are then executed by it or via distribution to other connectors, such as the internal connector 730, in other networks. After successful processing, the web service returns a confirmation.

An example for the actions of a connector for the purpose of data administration in different networks (management of a virtual data stock) would be:
Read data—A communication with another network is not necessary. There is no own action. The command is forwarded to the data administration in the own network unchanged.

### All Other Commands:

Send—Forwarding of the command to the data administration in the own network.
   Forwarding of the command to the connector that is assigned to the network, with which communication is to take place.
Receive—Reception of a command from the memory by the connector assigned to the own network.
   Forwarding of the command to the data administration in the own network.

Another example would be the actions of a connector for the purpose of data administration in different networks (management of a virtual data stock):
Send—Conversion of the command from the specific form of the data administration in the own network into an internal, neutral form.
   Writing of the converted commands into a post box specified for communication with the respective connector for the other network.
Receive—Continually recurring reading (so called “polling”) of the post box or boxes assigned to it.
   When receiving commands (i.e. the read PO box was filled), conversion of the internal, neutral command to the specific form of data administration in the own network.
   Forwarding of the command to this.

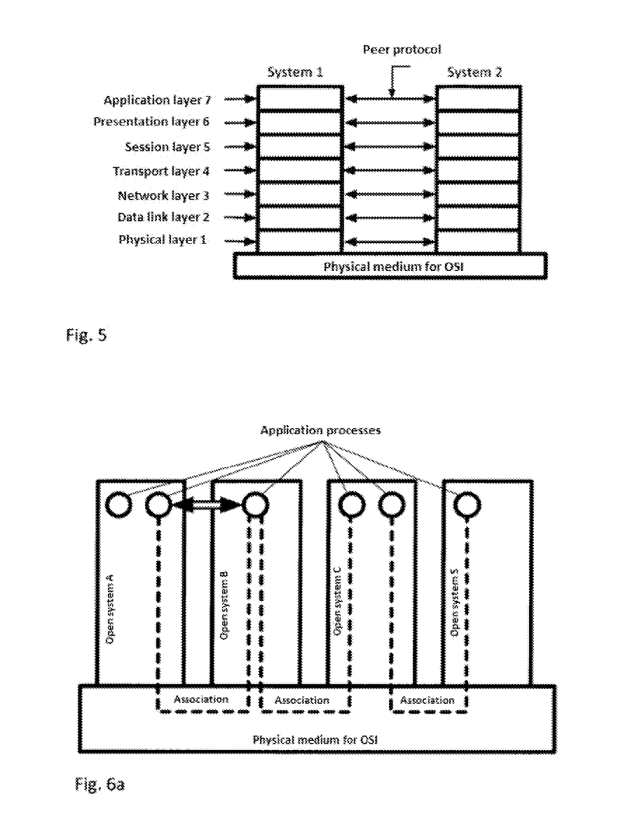

The communication between application and connector takes place application-specifically and on the respective communications layer. In the OSI standard, the communication corresponds to the layers five to seven, i.e. the Session Layer (Layer 5), the Presentation Layer (Layer 6) and specifically the Application Layer (Layer 7), i.e. an application protocol is used. The layers of the OSI standard are illustrated in FIG. 5. The OSI standard comprises seven layers:

a) Application layer, layer 7;

b) Presentation layer, layer 6;

c) Session layer, layer 5;

d) Transport layer, layer 4;

e) Network layer, layer 3;

f) Data link layer, layer 2;

g) Physical layer, layer 1.

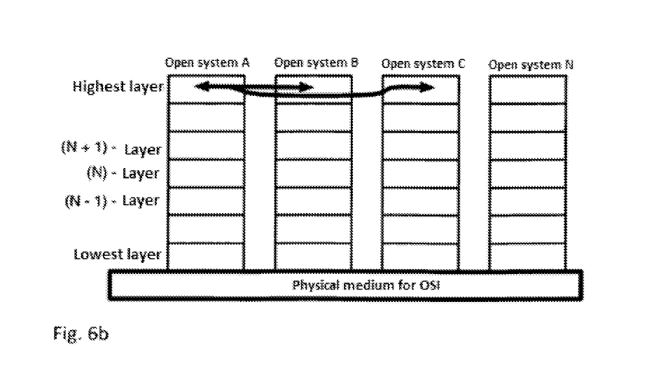

FIGS. 6a and 6b show the communication of this description. The communication does not take place in the sense of the standard implementations of the layer hierarchy of the ISO/OSI-specification (e.g. TCP/IP). The application commands usually transmitted to ISO/OSI-layer 7 are intercepted by the connectors 500, 700, 800. The transmission takes place on a dedicated or owned protocol stack that directly connects the application to the high layers via connectors. There is no vertical communication (from layer-N to layer-(N-1) to the physical network layer and once again up). The area of influence of the sending network thus finally ends at the connectors 500, 700, 800. This permits transmitting information to application layers horizontal and to several systems in parallel.

To implement a consistent data stock in the distributed databases 50, 70, the connectors 500, 700 use the following strategy that is illustrated at the example of SQL-capable databases:
Execute all DQL-instructions (Data Query Language) on the local DB
For all other instructions (Data Definition Language [DDL], Data Manipulation Language [DML], Data Control Language [DCL]):
   Pack them in a Transaction Control environment and execute them each on the local and the respective other data sources.
   Send a COMMIT to all after complete execution without errors.
   Send a ROLLBACK to all in case of error.
      Optionally, it is possible easily with the help of query transformations that even data sources with different SQL-dialects execute identical statements.

The system may be implemented as software or hardware or a combination of them.

A person skilled in the art will recognize when reading the present description that individual ones of the features described in the examples can be left away or added, and that not all features are necessary for execution of the invention.

1. An interface for data transmission from a first data-processing system to at least one second data-processing system, wherein the interface comprises:
a first application-specific connector that can interchange, with a first application of the first data-processing system, changes specific for the first application;3
at least one second application-specific connector that can interchange, with a second application of at least one second data-processing system, changes specific for the second application; and
a data memory to which the first connector and the second connector have access.

2. Interface according to claim 1, wherein the first data-processing system and the second data-processing system are data networks isolated from each other.

3. Interface according to claim 1, wherein the memory comprises at least one first area in to which only the first connector can write.

4. Interface according to claim 1, wherein the interface is bidirectional and the memory comprises at least a second area into which only the second connector can write.

5. Interface according to claim 1, wherein the memory is the only connection between the first data-processing system and the second data-processing system.

6. Interface according to claim 1, wherein a connection between the first application and the first connector and/or the at least second application and the at least second connector is implemented in layers five to seven of the Open System Interconnection Reference Model.

7. Method for data transmission from a first data-processing system to at least one second data-processing system, wherein the method comprises:
Reception of a change to be transmitted from a first application from the first data-processing system;
Saving of the change to be transmitted in a memory by a first connector;
Reading of the saved change to be transmitted in the memory by a second connector;
Determination of whether the change to be transmitted is to be forwarded to the second data-processing system or not; and
Forwarding of the change to be transmitted to a second application in the second data-processing system if it has been determined that the change to be transmitted is to be forwarded to the second data-processing system.

8. Method according to claim 7, wherein the reading of the memory is repeated by the second connector at specified intervals or is taking place upon request or in a combination of both.

9. Method according to claim 7, wherein the reading of the change stored in the memory comprises a determination of whether a new change to be transmitted was stored in the memory.

10. Method according to claim 7, wherein, during the forwarding of the change to be transmitted to the at least second application, a receipt confirmation is returned.

11. Method according to claim 7, wherein the first connector converts the format of the change to be transmitted from a first application-specific format into a generally valid format before saving the change to be transmitted.

12. Method according to claim 7, wherein the second connector converts the format of the change to be transmitted to a second application-specific format for the second application before forwarding the change to be transmitted.

13. Method according to claim 7, wherein the data transmission between the first application and the first connector and/or the at least second application and the at least second connector taking place in layers five to seven of the Open System Interconnection Reference Model.

14. Interface system for data transmission from a first data-processing system to at least one second data-processing system, wherein the interface system comprises:
a first application-specific connector, which can interchange, with a first application of the first data-processing system, data specific for the first application;
a second application-specific connector, which can interchange, with a second application of at least one second data-processing system, data specific for the second application;
and
a data memory to which the first connector and the second connector have access,
with a change from the first application being stored in the memory by the first connector and being read from the memory by the second connector.

15. Interface system according to claim 14, wherein the second connector determines whether the read change to be transmitted is transmitted to the second data-processing system.

16. Interface system according to claim 14, wherein the memory comprises at least one first area into which only the first connector can write.

17. Interface system according to claim 14, wherein the interface is bidirectional and the memory comprises at least one second area into which only the second connector can write.

18. Interface system according to claim 14, comprising an interface for data transmission from a first data-processing system to at least one second data-processing system, wherein the interface comprises:
a first application-specific connector that can interchange, with a first application of the first data-processing system, changes specific for the first application;3
at least one second application-specific connector that can interchange, with a second application of at least one second data-processing system, changes specific for the second application; and
a data memory to which the first connector and the second connector have access.

19. Interface system according to claim 14, which for data transmission from a first data-processing system to at least one second data-processing system, wherein the method comprises:
reception of a change to be transmitted from a first application from the first data-processing system;
saving of the change to be transmitted in a memory by a first connector;
reading of the saved change to be transmitted in the memory by a second connector;
determination of whether the change to be transmitted is to be forwarded to the second data-processing system or not and
forwarding of the change to be transmitted to a second application in the second data-processing system if it has been determined that the change to be transmitted is to be forwarded to the second data-processing system.
